(19) United States
(12) Patent Application Publication
(10) Pub. No.: US 2013/0147949 A1
(43) Pub. Date: Jun. 13, 2013

(54) AD HOC SECURITY DEVICE NETWORK

(71) Applicant: Travis Engelman, San Francisco, CA (US)

(72) Inventor: Travis Engelman, San Francisco, CA (US)

(73) Assignee: ACLARITY SYSTEMS, LLC, San Francisco, CA (US)

(21) Appl. No.: 13/441,605

(22) Filed: Apr. 6, 2012

Related U.S. Application Data
(60) Provisional application No. 61/570,231, filed on Dec. 13, 2011.

(51) Int. Cl. H04N 7/18

(52) U.S. Cl. 348/143; 348/E07.085

(57) ABSTRACT

One example embodiment includes an ad hoc security device network. The ad hoc security device network includes a gateway, wherein the gateway is configured to connect to an external network. The ad hoc security device network also includes a security device. The security device is configured to connect to the external network through the gateway and monitor a desired condition in a particular area.

### CROSS-REFERENCE TO RELATED APPLICATIONS

This application claims the benefit of and priority to U.S. Provisional Patent Application Ser. No. 61/570,231 filed on Dec. 13, 2011, which application is incorporated herein by reference in its entirety.

### BACKGROUND OF THE INVENTION

Security cameras and other security devices are quite common. The cameras are positioned to record activities in certain areas. The activities may be expected or the footage may be used to later determine if something occurred about which desired authorities should be informed. I.e., the camera may be positioned to record people expected in a certain area or can be positioned to record an area that is expected to be empty or experience only light traffic.

The proliferation of security cameras has led to a decrease in crime and can often be used to solve crimes that occur in the area. For example, when a crime occurs, police often look around the area to determine if any cameras are present that they can review to see if the video reveals potential clues. These clues have proved decisive in solving crimes and catching criminals.

In addition, security devices can allow a single person or group of people to monitor a particular area. For example, the security device can allow a single security guard to monitor the perimeter of a building. The images are relayed to monitors and are viewed by the security guard who can call others or take action if suspicious activities are noticed.

The installation of security devices is, however, expensive. There is an infrastructure that must be installed in order to relay the information captured by the security devices. For example, many security cameras require the installation of video cable, or other wired networks, to relay the images. Some cameras allow for connection over a wireless network. However, over a large area this can require the installation of a number of wireless routers, each of which must be connected, in turn, to a wired network. Therefore, a wireless network still may still require expensive installation.

Accordingly, there is a need in the art for a security device that can connect to other security devices to form a network, even when outside of a connection area of a network.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an ad hoc security device network. The ad hoc security device network includes a gateway, wherein the gateway is configured to connect to an external network. The ad hoc security device network also includes a security device. The security device is configured to connect to the external network through the gateway and monitor a desired condition in a particular area.

Another example embodiment includes an ad hoc security device network. The ad hoc security device network includes a gateway, wherein the gateway is configured to connect to an external network. The ad hoc security device network also includes a first security device. The first security device is configured to connect to the external network through the gateway and monitor a first desired condition in a first area. The ad hoc security device network further includes a second security device. The second security device is configured to connect to the gateway through the first security device and monitor a second desired condition in a second area.

Another example embodiment includes a method for creating an ad hoc security device network. The method includes providing a gateway, wherein the gateway is configured to connect to an external network. The method also includes connecting a first security device to the gateway, wherein the security device is configured to monitor a first desired condition in a first area. The method further includes connecting a second security device to the gateway, wherein the second security device is configured to monitor a second desired condition in a second area.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a system for connecting to an external network using an ad hoc security device network;

FIG. 2 illustrates an example of an ad hoc security device network;

FIG. 3 illustrates an example of a security device;

FIG. 4 is a flowchart illustrating a method of creating an ad hoc security device network; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

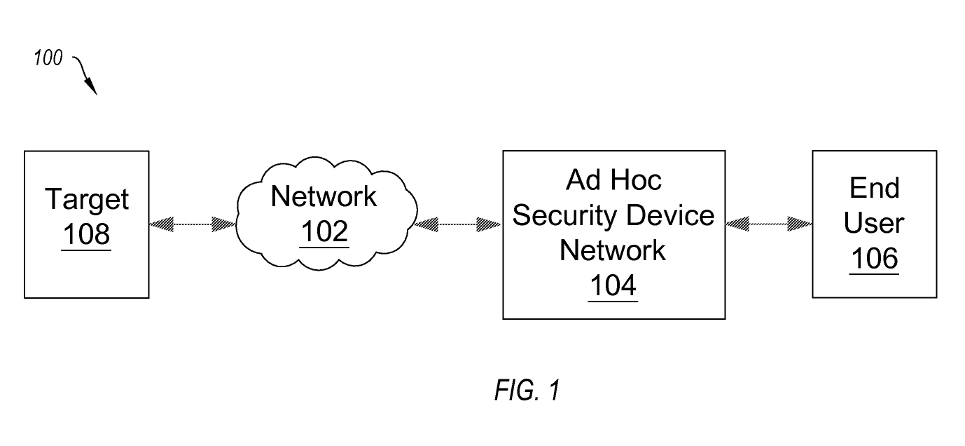

FIG. 1 is a block diagram illustrating an example of a system 100 for connecting to an external network using an ad hoc security device network. In at least one implementation, the system 100 can allow a user to access the security devices over the external network. Additionally or alternatively, the system 100 can allow a user to connect to the external network over the ad hoc security device network.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include an ad hoc security device network 104. In at least one implementation, the ad hoc security device network 104 can include a network of security devices which form a data network. I.e., the ad hoc security device network 104 can include one or more security devices connected to one another either wireless or through a wired connection. The security devices can allow connections to the network 102 which may not otherwise be available, as described below.

FIG. 1 further shows that the system 100 can include an end user 106. In at least one implementation, the end user 106 can connect to the network 102 over the ad hoc security device network 104. That is, the ad hoc security network 104 can act as a “bridge” allowing the end user to connect to the network 102 when such a connection would be otherwise unavailable. For example, the ad hoc security device network 104 can allow a user, such as an individual using a computer, laptop, table, smart phone or other device, to wirelessly connect to the Internet in the absence of another such connection. Additionally or alternatively, the end user 106 can include a security device which is unable to directly connect to the network 102.

FIG. 1 additionally shows that the system 100 can include a target 108. In at least one implementation, the target 108 can include any user, database, webpage, website, domain, subdomain, web post, Uniform Resource Identifier (“URI”), Uniform Resource Locator (“URL”), non-permanent posting such as e-mail and chat, or other data located on or accessible through the network 102. For example, the target 108 can include a user who desires to access a security device acting as the end user 106. Additionally or alternatively, the target 108 can include a target file that a user, acting as the end user 108, wishes to access.

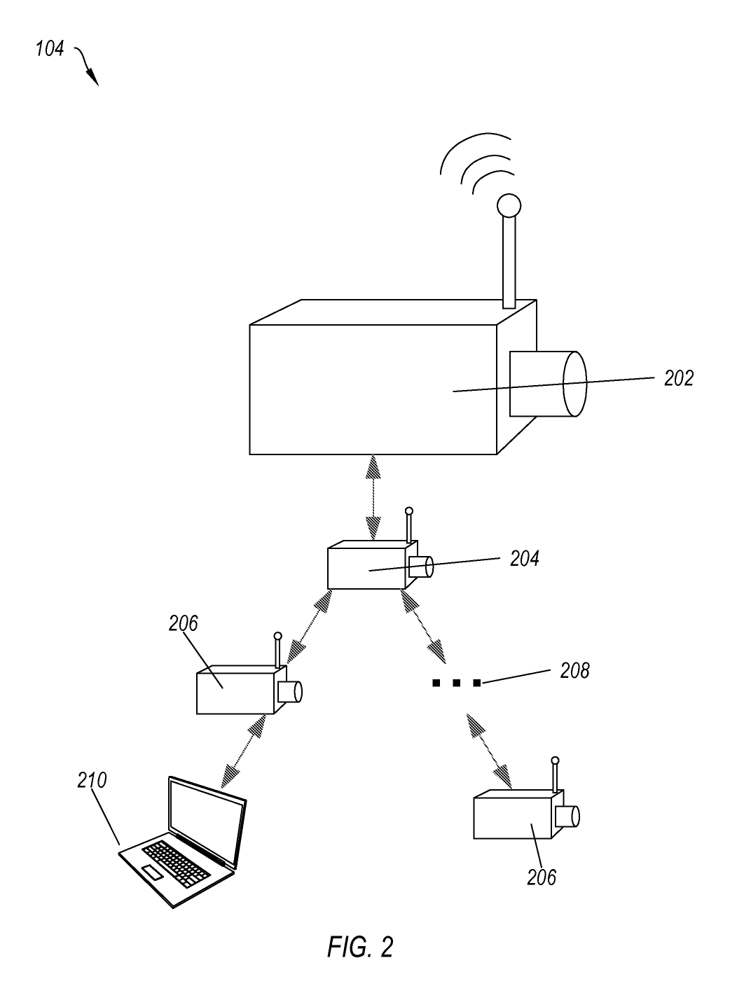

FIG. 2 illustrates an example of an ad hoc security device network 104. In at least one implementation, the ad hoc security device network 104 can allow multiple security devices to connect to an external network. I.e., the ad hoc security device network 104 can allow security devices which are not able to directly connect to an external network to connect to the external network through other security devices, as described below.

FIG. 2 shows that the ad hoc security device network 104 can include a gateway 202. In at least one implementation, the gateway 202 can include a network point that acts as an entrance to another network. I.e., the gateway 202 can be configured to connect the ad hoc security device network 104 to an external network, such as an intranet or the Internet. For example, the gateway 202 can be configured to interface with another network that uses different protocols. The gateway 202 can include devices, either in hardware or software, such as protocol translators, impedance matching devices, rate converters, fault isolators, or signal translators as necessary to provide system interoperability. It also requires the establishment of mutually acceptable administrative procedures between both networks.

In at least one implementation, the gateway 202 can include a security device. I.e., the gateway 202 can include any security device which is capable of connecting to an external network. For example, the gateway 202 can include a security device which has connected to the Internet and is capable of acting as a bridge to other security devices. Additionally or alternatively, the gateway 202 can include a router or other device capable of connecting to both security devices and to the external network.

FIG. 2 shows that the ad hoc security device network 104 can include a node 204. In at least one implementation, a node 204 can include a connection point for other devices. For example, the node 204 can include a security device or other device that is attached to the gateway 202, and is capable of sending, receiving, or forwarding information over a communications channel.

In at least one implementation, the node 204 can include a security device. I.e., the node 204 can include any security device which is capable of connecting to the gateway 202. For example, the node 204 can include a security device which has connected to the gateway 202 and is capable of acting as a bridge to other security devices. I.e., the node 204 can include a security device which is capable of forwarding communications from other security devices and generating communications which will be sent to the gateway 202. Additionally or alternatively, the node 204 can include a bridge or other device capable of receiving communications from security devices and forwarding the communications to the gateway 202.

FIG. 2 further shows that the ad hoc security network 104 can include one or more end nodes 206. In at least one implementation, the one or more end nodes 206 can include security devices which are communicating over the ad hoc security network 104. That is, the one or more end nodes 206 can include security devices which will originate or receive communications, but will not forward communications from other nodes 204. One of skill in the art will appreciate that the designation of a security device as an end node 206 may be transitory. That is, a security device may act as an end node 206 but may be capable of acting as a node 204 if the need arises.

FIG. 2 additionally shows that the ad hoc security network 104 can include one or more intermediate nodes 208. In at least one implementation, the intermediate nodes 208 can include any desired number of nodes. I.e., the ad hoc security device network 104 can grow to include any desired number of security devices. For example, each node 204, end node 206 and intermediate node 208 need not be constantly transmitting over the ad hoc security network 104. Instead, the each node 204, end node 206 and intermediate node 208 can transmit only when requested, limiting data traffic to a manageable level. Additionally or alternatively, each node 204 and intermediate node 208 can be equipped to handle sufficient data traffic to allow each node 204, end node 206 and intermediate node 208 to transmit to the gateway 202 simultaneously.

In at least one implementation, the one or more intermediate nodes 208 can be adjusted according to need. For example, if any one of the one or more intermediate nodes 208 fails, the data from the end node 206 can be routed to the gateway 202 through a different intermediate node 208. I.e., the ad hoc security network 104 can self-repair if required. Additionally or alternatively, if the traffic through an intermediate node 208 becomes too high for the intermediate node 208 to handle, the data can be route through alternative intermediate nodes 208 where available.

FIG. 2 also shows that the ad hoc security network 104 can include a connecting device 210. In at least one implementation, the connecting device 210 can include any device which the user wishes to connect to the external network through the gateway 202. For example, the connecting device 210 can include a cell phone, a smart phone, a tablet, a laptop/computer or any other desired device.

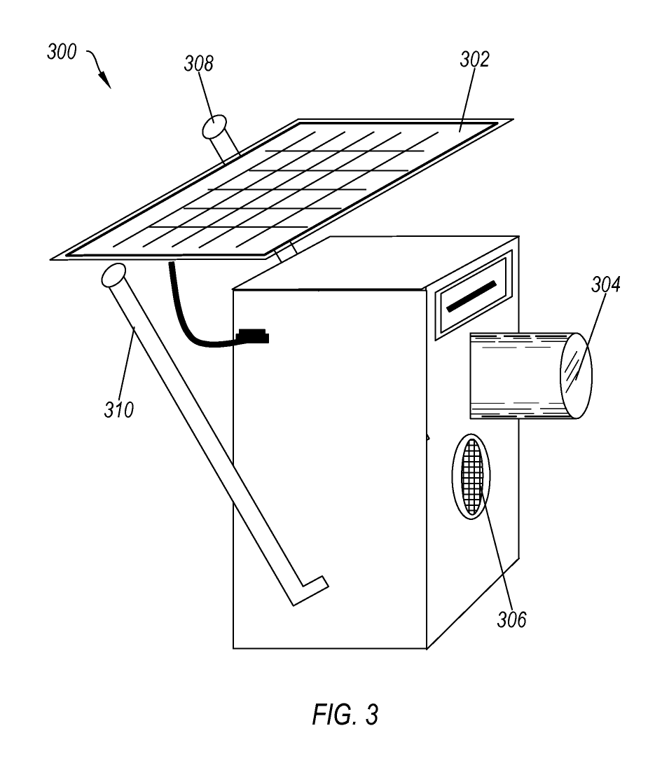

FIG. 3 illustrates an example of a security device 300. In at least one implementation, the security device 300 can include any device meant to monitor a particular area. For example, the security device 300 can include cameras, microphones, light sensors, motion sensors, lights, locks, thermometers, environmental sensors or any other device which can electronically monitor a desired condition in a particular area.

FIG. 3 shows that the security device 300 can include a power source 302. In at least one implementation, the power source 302 can allow the security device 300 to monitor the desired area. For example, the power source 302 can include a solar panel, batteries, capacitors, plugs, generators or any other power source. One of skill in the art will appreciate that the security device 300 can include more than one power source 302. For example, the security device 300 can include a plug or electrical connection and have a battery or solar panel available for a backup power source.

FIG. 3 also shows that the security device 300 can include one or more sensors 304. In at least one implementation, the one or more sensors 304 can record or monitor a desired condition in an area. For example, the one or more sensors 304 can include cameras, microphones, light sensors, motion sensors, lights, locks, thermometers, environmental sensors or any other sensors. One of skill in the art will appreciate that any device for monitoring a desired parameter is contemplated herein.

FIG. 3 further shows that the security device 300 can include one or more outputs 306. In at least one implementation, the one or more outputs 306 can allow the security device to transmit visual, auditory, or other signals. For example, the one or more outputs can include a light, a speaker, a display or any other signal meant to communicate with individuals in the area.

FIG. 3 additionally shows that the security device 300 can include a wireless networking antenna 308. In at least one implementation, the wireless networking antenna 308 can allow the security device 300 to receive and transmit data. For example, the wireless networking antenna 308 can include a WiFi antenna. In particular, the wireless networking antenna 308 can allow the security device 300 to exchange data with other security devices 300 or with other external devices. I.e., the wireless networking antenna 308 can allow the security device 300 to act as a gateway 202 or a node 204, as described above with regard to FIG. 2.

FIG. 3 also shows that the security device 300 can include a cellular data antenna 310. In at least one implementation, the cellular data antenna 310 can allow the security device 300 to connect to a cellular data network. For example, the cellular data antenna can include a transceiver that is configured to connect the security device 300 to a 3G or 4G data network. The cellular data antenna 310 can allow the security device 300 to act as a gateway 202, as described above with regard to FIG. 2.

One of skill in the art will appreciate that the cellular data antenna 310 is one example of a connection method to an external network and that other connection methods are contemplated herein. For example, the security device 300 can connect to an external network using a wired connection, such as coax or Ethernet, or a wireless connection.

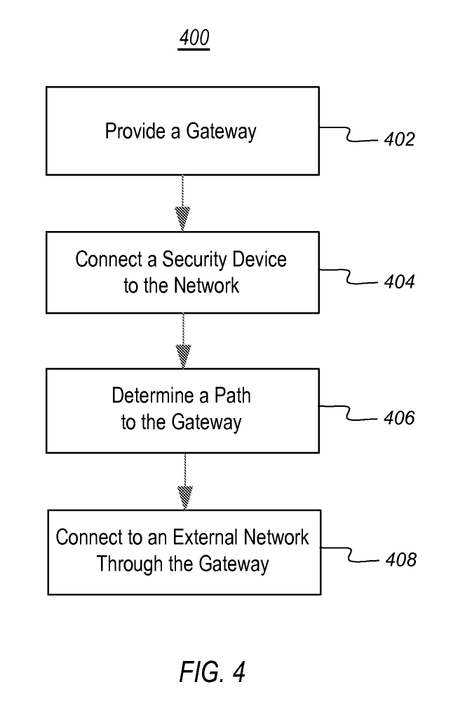

FIG. 4 is a flowchart illustrating a method 400 of creating an ad hoc security device network. In at least one implementation, the method 400 can allow the ad hoc security device network to update dynamically. I.e., the method 400 can allow the ad hoc security network to accommodate the addition or removal of additional devices. One of skill in the art will appreciate that the method 400 can be carried out by users or by software or in any other manner, unless otherwise specified.

FIG. 4 shows that the method 400 includes providing 402 a gateway. In at least one implementation the gateway includes any device which will allow the ad hoc security device network to connect to an external network. For example, the gateway can include any security device which is capable of connecting to an external network. I.e., the gateway can include a security device which has connected to the Internet and is capable of acting as a bridge to other security devices. Additionally or alternatively, the gateway can include a router or other device capable of connecting to both security devices and to the external network.

FIG. 4 also shows that the method 400 can include connecting 404 a security device to the network. In at least one implementation, the security device can include any device for monitoring conditions in an area, as described above. The security device can connect 404 directly to the gateway. Additionally or alternatively, the security device can connect 404 to the gateway through one or more nodes. The nodes can include a security device capable of forwarding communications or any other device capable of forwarding communications.

FIG. 4 further shows that the method 400 can include determining 406 a path to the gateway. In at least one implementation, the path can be based on any relevant factors. For example, the path can be routed through the nearest node. Additionally or alternatively, the path can be routed to minimize traffic through a particular node. For example, if a node is currently routing traffic for multiple security devices a longer path may be selected through nodes that are routing traffic for a smaller number of security devices.

FIG. 4 additionally shows that the method 400 can include connecting 408 to an external network through the gateway. In at least one implementation, the data from the security device is passed to the external network through any connecting nodes to the gateway, which may translate or otherwise modify the data. Data from the security device can include data produced by the security device or data forwarded by the security device, such as from a connected phone, table, laptop or other device, as described above. Additionally or alternatively, information from the external network can be passed through the gateway to the security device.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

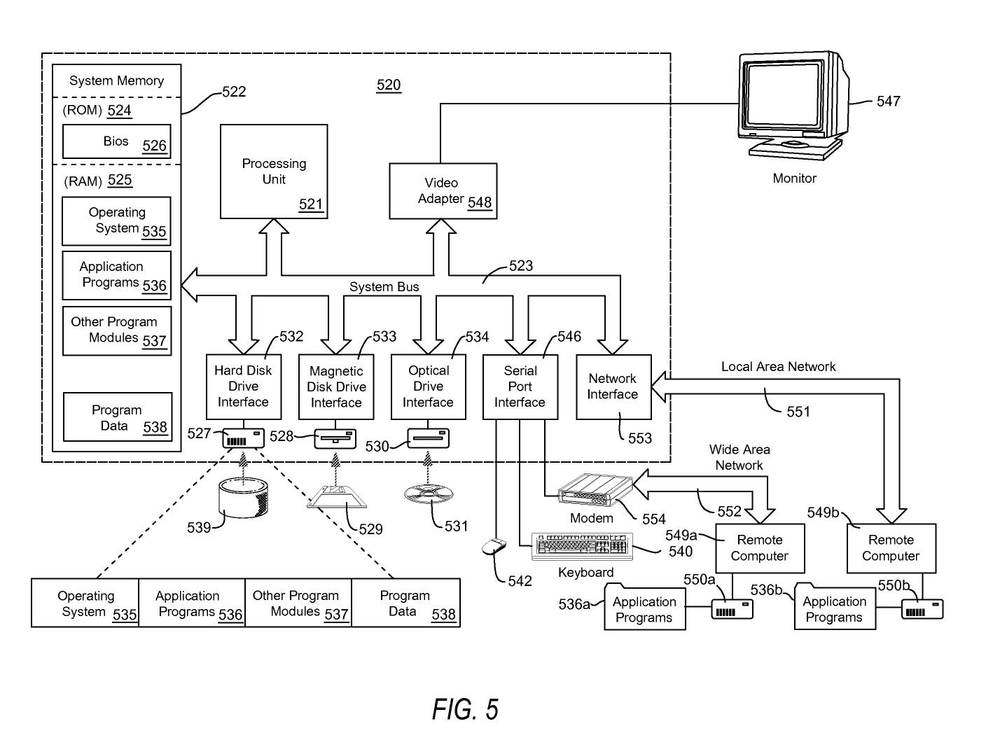

FIG. 5, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, motion detectors or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An ad hoc security device network, the ad hoc security device network comprising:
a gateway, wherein the gateway is configured to connect to an external network;
a security device, wherein the security device is configured to:
connect to the external network through the gateway; and
monitor a desired condition in a particular area.

2. The ad hoc security device network of claim 1 further comprising a second security device, wherein the second security device is configured to monitor the desired condition in a second area.

3. The ad hoc security device network of claim 2, wherein the second security device is connected to the gateway through the security device.

4. The ad hoc security device network of claim 1, wherein the security device includes a video camera.

5. The ad hoc security device network of claim 1, wherein the gateway includes a security device which is configured to connect to the external network.

6. The ad hoc security device network of claim 1, wherein the security device is configured to allow an external device to connect to the gateway.

7. The ad hoc security device network of claim 1, wherein the external device includes at least one of:
a computer;
a laptop;
a tablet; or
a smart phone.

8. The ad hoc security device network of claim 1, wherein the external network is the Internet.

9. The ad hoc security device network of claim 1, wherein the external network is a cellular data network.

10. The ad hoc security device network of claim 1, wherein a user can connect to the security device from the external device via the gateway.

11. The ad hoc security device network of claim 10, wherein the user can receive data from the security device.

12. The ad hoc security device network of claim 10, wherein the user can transmit a command to the security device.

13. An ad hoc security device network, the ad hoc security device network comprising:
a gateway, wherein the gateway is configured to connect to an external network;
a first security device, wherein the first security device is configured to:
connect to the external network through the gateway; and
monitor a first desired condition in a first area; and
a second security device, wherein the second security device is configured to:
connect to the gateway through the first security device; and
monitor a second desired condition is a second area.

14. The system of claim 13, wherein the second security device connects to the first security device using a wireless connection.

15. The system of claim 13, wherein the first security device connects to the gateway using a wireless connection.

16. The system of claim 13 further comprising a third security device, wherein the third security device is configured to:
monitor a third desired connection in a third area; and
connect to the gateway through the first security device.

17. The system of claim 13 further comprising a third security device, wherein the third security device is configured to:
monitor a third desired connection in a third area; and
connect to the gateway through the second security device.

18. A method for creating an ad hoc security device network, the method comprising:
providing a gateway, wherein the gateway is configured to connect to an external network;
connecting a first security device to the gateway, wherein the security device is configured to monitor a first desired condition in a first area; and
connecting a second security device to the gateway, wherein the second security device is configured to monitor a second desired condition in a second area.

19. The system of claim 18, wherein the second security device is connected to the gateway through the first security device.

20. The system of claim 18 further comprising:
connecting a third security device to the gateway, wherein the third security device is configured to monitor a third desired condition in a third area; and
determining the best connection path to the gateway, wherein determining the best connection path includes:
determining whether the path should be through the first security device; or
determining whether the path should be through the second security device.
